(19) United States
(12) Patent Application Publication
(10) Pub. No.: US 2010/0131488 A1
(43) Pub. Date: May 27, 2010

(54) Digital Images of Web Pages

(75) Inventors: Ali Dasdan, San Jose, CA (US); Marcin M. Kadluczka, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/324,607

(22) Filed: Nov. 26, 2008

(51) Int. Cl. G06F 7/06; G06F 17/30

(52) U.S. Cl. 707/709; 707/E17.108

(57) ABSTRACT

Embodiments of methods, apparatuses, or systems relating to digital images of web pages are disclosed.

### BACKGROUND

1. Field

The subject matter disclosed herein relates to digital images of web pages.

2. Information

Many believe that navigating the Internet—the World Wide Web in particular—may be a time-consuming and occasionally perilous undertaking. As the Internet continues to increase in size, it seems all the more difficult for searchers to find relevant information.

In addition, not only do searchers spend time and effort searching to find what they want, they often do not want what they find. For example, searchers may occasionally chance upon malicious software, or so-called malware, such as computer viruses, spyware, or adware, just to name a few. The effects of pernicious software may vary from slowing the performance of a computer, to availing to third-parties personal or private information about the searcher, or his or her computing platform. Likewise, searchers may stumble upon content or subject matter that they believe is inappropriate. Many agree that irrelevant information, malware or unsolicited content may represent just a few of the concerns with the current Web search paradigm. Accordingly, other methods or technologies may be desired.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a flow chart depicting an embodiment of a method to serve a digital image of a web page.

FIG. 2 is a schematic diagram depicting an embodiment to collect digital images of a web pages.

FIG. 3 is a schematic diagram depicting an embodiment to serve digital images of web pages with Web search results.

FIG. 4 is a schematic diagram depicting an embodiment of a system to serve digital images of web pages.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context. Therefore, the particular context of the description or the usage of these terms may provide helpful guidance regarding inferences to be drawn for that particular context.

Likewise, the terms, “and,” “and/or,” and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's memories, registers, and/or other information storage, transmission, and/or display devices. Thus, data, of course, may include, for example, any information which may be capable of being perceived, employed, stored, or transmitted by a computing platform, such as program code, executable instructions, or text, as non-limiting examples.

As mentioned previously, several concerns regarding the current Web search paradigm may exist. One concern, for example, may be that it is time-consuming for searchers to find relevant information on the World Wide Web. Or, similarly, searchers may routinely spend unnecessary time uncovering irrelevant information. There are several reasons why this may occur. One reason, for example, may be that search engine technology, which is frequently used to navigate the Web, generally serves as an imperfect proxy of a searcher's desired search results. Thus, occasionally, well-thought out search terms entered into a search engine may nonetheless result in irrelevant results or wasted time.

Many search engines continue to look for ways to mitigate this problem by, for example, attempting to increase the relevance of search results. One approach, for example, may be to update search technology with information about searcher actions after the searcher leaves the engine's search results page. That is, information about a searcher's actions subsequent to his or her interaction on the engine's search page may potentially increase the relevance of search results. Information about this type of post-search activity, however, has sometimes been difficult or onerous to track.

Search engines may employ various techniques in an attempt to obtain information about a searcher's post-search activity. In one technique, for example, a search engine may use a toolbar to track searcher actions. Toolbars, however, may be limited in breadth and have been known to present numerous security concerns. Thus, their use is limited. In another technique, for example, a search engine may display links on its search results page that may also exist on a destination page. This may permit a searcher to access linked content of a destination page on the engine's search results page, whereas this link would otherwise be accessed by going to the destination page itself. These “quick links” or “quicklinks,” however, are also limited in their number and applicability. In many instances, for example, the search results page may display only a few links located on the destination page. Thus, searcher activity beyond the quicklinked content, which may amount to a large portion of the destination page, may be difficult to track. In another technique, a search engine may utilize the services of a third party, such as Comscore, Inc., for example, to track post-search activity. Third-party vendors, however, also have a limited ability to collect information on post-search activity. Thus, their use may be limited.

The security of web pages may be another concern regarding the current search paradigm. One common way to access information on the Web is to navigate from website to website. Navigating between websites, however, may be fraught with peril. Searchers may sometimes access unfamiliar or untrustworthy websites that contain pernicious content; for example, a website, or links on a website, may avail the searcher's computer to malware. This is a common problem for anyone who has ever navigated the Web. A multi-billion dollar industry in virus and spyware protection and firewall design exists in an attempt to combat this concern. In addition, even trusted website, which may be less likely to harbor malware, may inundate searcher computers with cookies or adware that may engender security or privacy concerns.

Unsolicited content may be another concern regarding the current search paradigm. For example, searchers may enter what they believe to be innocuous or benign search criteria and unexpectedly encounter content which they may deem to be inappropriate or unwanted. Many experts, particularly with regard to web access by minor children, believe that industry attempts to mitigate this problem, such as content filtering, have been insufficient or ineffective. Accordingly, other methods or technologies may be desired.

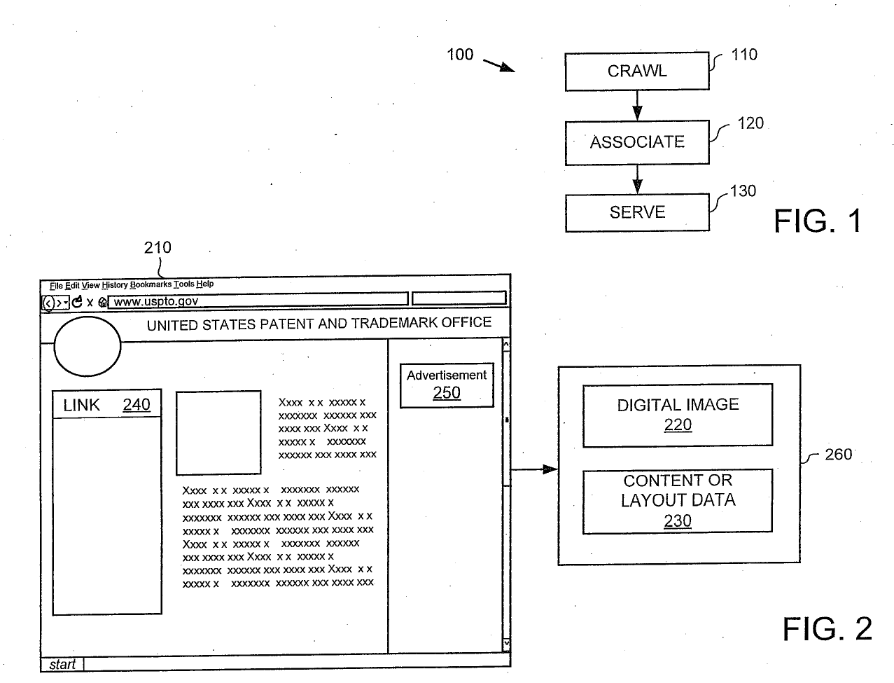

FIG. 1 is a flow chart depicting embodiment 100 of a method to serve a digital image of a web page. In this embodiment, operation 110 depicts crawling the Web. Of course, in other embodiments, operation 110 may not be limited to crawling the Web; for example, operation 110 may include crawling the Internet or an intranet, as non-limiting examples. In this embodiment, crawling may be performed by a computing platform operating crawling logic or software, such as may be utilized by a search engine, such as Yahoo!, for example.

In this embodiment, a computing platform may crawl the Web to collect digital images of web pages to index in a database. For example, software or logic operating on a computing platform may create a digital image of a web page that is being crawled. In this context, the phrase “digital image” is intended to mean a representation of a two-dimensional image using digital pixel values. Accordingly, a digital image may be encoded in various forms, such as, for example, a TIF, GIF, PDF, JPEG, Bit Map, PNG, SVG, or other digital image format, as non-limiting examples.

While there are a variety of ways to create a digital image of a web page, one way to do some may comprise generating a digital image based, at least in part, on an in-memory representation of the web page. To illustrate, generating a digital image in an embodiment may operate in a manner conceptually similar to a browser loading a web page. For example, crawling a URL is similar to loading the corresponding web page in a web browser and viewing it for reading its content or following its links. While loading the page, a browser may also load content required to display the page and build an in-memory representation, which, for example, may involve applying CSS rules and executing JavaScript code. In the in-memory representation, the coordinates of content, such as links, in the web page may also be stored. A digital image may be generated from the in-memory representation using one or more browser plug-ins or programs by mapping this representation to a digital image. As mentioned above, further encoding of the image in various image formats is possible.

Similarly, in this embodiment, operation 110 depicts crawling the Web to collect web page content or layout data. Content or layout data may of course include any data relating to the content or layout of a web page, such as HTML, CSS, hyperlinks, or advertisements, as non-limiting examples. In an approach similar to that discussed above for compiling digital images of a web page, a computing platform may use software or logic to crawl the Web to collect content or layout data to index in a database.

Reference to FIG. 2 may help to illustrate the above approach. For example, assume 210 in FIG. 2 depicts the actual USPTO home web page, such as a client may receive in response to an HTTP request to receive the web page at URL www.uspto.gov from a USPTO server. Operation 110, as mentioned previously, may crawl a web page, such as web page 210, to create a digital image of that web page, which in this illustration, for example, creates digital image 220 stored in database 260. In this illustration, created digital image 220 may be a static image of web page 210, such as a JPEG or other type of digital image, as a non-limiting example. Here, image 220 may be an identical, or substantially identical, representation of web page 210. While an identical, or substantially identical, representation of web page 210 may be created in this embodiment, this may not occur in other embodiments. For example, in other embodiments, created digital images, such as image 220, may modify, such as simplify or enhance, for example, a representation of a web page such that a digital image of a web page created by operation 110 may differ from the actual web page.

To continue an illustration, operation 110 may collect content and layout data, depicted in FIG. 2, as content and layout data 230. Here, for example, operation 110 may collect content and layout data 230, such as link 240, CSS layout data (not depicted), or advertisement 250 from web page 210 to index in database 260. Of course, a crawler performing operation 110 may collect any content data, layout data, or digital images of web pages, or any portions thereof, at any time or via any number of iterations. Accordingly, a variety of embodiments exist, which may depend on what may be crawled or collected and the frequency at which it may be crawled or collected.

Returning to FIG. 1, operation 120 in embodiment 100 depicts associating collected content or layout data of a web page with a corresponding digital image of a web page. In embodiment 100, for example, a database may associate collected layout data, such as coordinates, for example, by processing layout data, such as CSS rules, with corresponding, collected content data, such as links, and a corresponding digital image of a web page. For example, returning to FIG. 2, a database, such as database 260, may associate collected content and layout data 230 with a corresponding collected digital web page image 220. One or more databases, such as database 260, may associate layout, content and image data, for example, by operating software or logic capable of operating on the database.

Operation 120, in embodiment 100, associates content and layout data with a digital image in a database such that, if served, the digital image may be embedded with associated content or layout data. For example, though many approaches exist, one approach to embed content or layout data with a digital image may be to map, utilizing layout data, content data with a corresponding digital image. As mentioned previously, the location on the page, or coordinates, of various web page content may be known and collected. Accordingly, web page content may be mapped to the digital image. Thus, for example, content may be embedded, by utilizing a grid or matrix under a digital image, for example, such that content may be accessible, if served, by client selection through a graphical user interface, such as a mouse click, on a part of the digital image that may correspond to associated embedded content. Another approach to embed content or layout data, for example may be to transparently superimpose content or layout data on an image such that content may be accessible, if served, by client selection through a graphical user interface, such as a mouse click, on a part of the digital image that may correspond to associated embedded content.

Of course, the above example is merely an example; accordingly, the scope of claimed subject matter is not so limited. In another embodiment not depicted herein, for example, operation 120 may associate portions of collected content data or layout data with a corresponding image. Thus, not all collected content or layout data may be associated with an image. For example, in an embodiment, a portion of the links that may be associated may be links that users tend to access more frequently. Thus, prior user behavior on the web page may help determine which links may be associated. In yet another embodiment, operation 120 may associate new content or layout data with an image. For example, operation 120 may add additional content that was not part of collected content of the web page. To illustrate, additional content may include new advertisements, new links, or information about the web page on which the image may be based, such as the last time the image was updated, or user page activity. In other embodiments, operation 120 may modify a collected web page image, generate a new image, or alter the layout or location of content on a collected web page image, as a few additional examples.

The above are merely examples of claimed subject matter and accordingly do not limit its scope. To be clear, operation 120 may associate content or layout data with web page images in numerous ways. Accordingly, the resulting association of layout, content and image data may mirror that of the web page from which it was collected, or it may differ from it in a variety of ways, as just an example.

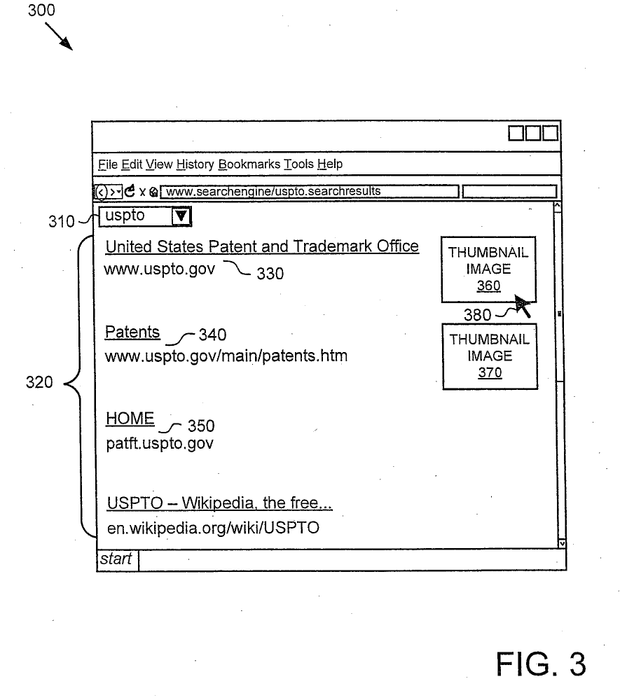

Operation 130 depicts serving a digital image of a web page. Operation 130 may be better illustrated with reference to FIG. 3. Embodiment 300 in FIG. 3 depicts a search engine serving a digital image of a web page with a set of search results, such as organic or sponsored search results, for example. For example, a searcher entered search term “USPTO” at 310 into a search field. In response, a search engine served search results 320 to the client's computing platform. We note briefly that, for ease of illustration, only four search results are bracketed within the screenshot in FIG. 3. Of course, more search results may be present.

Embodiment 300 may have been served, for example, via operation 130 in FIG. 1. Thus, in embodiment 300, images 360 and 370 represent served digital images of web pages, which are here depicted as being served with search results 320. For example, in this embodiment, image 360 depicts an image of a web page corresponding to search result 330. Similarly, image 370 depicts an image of a web page corresponding to search result 340.

In this embodiment, images 360 or 370 are depicted as thumbnail images, which may be bitmaps, JPEGs, or other types of digital images, as non-limiting examples. In this embodiment, images 360 or 370 may be thumbnail representations of web pages that are locatable by URL in the search results page. For example, thumbnail image 360 may be a thumbnail digital image of the USPTO web page depicted as search result 330. Of course, while an identical, or substantially identical, representation of the web page is depicted in this embodiment, this may not be the case in other embodiments. For example, as suggested previously, web page images, layout or content may be modified. Thus, the served image, for example, may be simplified or enhanced, or may have different content or layout than the actual web page. In an embodiment, for example, a served image may comprise a web page with some or all of the contents which may be associated with that page, yet the served image of this web page may appear dissimilar to the actual web page in various respects.

In embodiment 300, images 360 and 370 may be enlarged. For example, in this embodiment, a user may enlarge image 360 by moving cursor 380 over image 360 or by selecting image 360, such as by clicking on it. Accordingly, where image 360 enlarges in response to the cursor's position, a scripting program, such as JavaScript, for example, may be operating on the client's computing platform to detect mouse position. In another embodiment, for example, a user may be capable of accessing embedded content in a digital image without expanding the thumbnail. For example, it may be served in a blown-up size or in a window (e.g., pop-up window, new browser window, new browser tab), Of course, these images may be closed by moving the cursor out of the image or window, or by pressing on a “close” button associated with the window in which an image may be shown, as non-limiting examples. In yet another embodiment, an image of a web page may not be served with search results. For example, search result 350 does not have a corresponding thumbnail image. Thus, as an example, links may be used. Accordingly, in this instance, for example, a digital image may be served after the user selects, moves the cursor over, or otherwise accesses, a URL link in the search results page. This URL link may be served with search results, such as the URL link for search result 350, or may be served as a separate link (not depicted), such as a link displayed below thumbnail 370 (not depicted).

In embodiment 300, positioning cursor 380 over image 360 may produce a full screen or enlarged image of a digital image of web page, such as the digital image of web page 210 depicted in FIG. 2. For example, in embodiment 300, once thumbnail image 360 may be enlarged, it may appear to the searcher that he or she has navigated to the USPTO web page utilizing conventional Web techniques, such as a redirect, for example; however, the searcher, in this embodiment, is viewing an image of the USPTO web page that was served by a database, such as database 260.

To illustrate, assume web page 210 in FIG. 2 may not be the actual USPTO home web page as previously suggested; instead, assume web page 210 may be a digital image the USPTO home web page served to a client, for example, such as by database 260 as previously described. Web page 210, which is an image of the USPTO home page, may be served to a client with associated embedded content, such as link 240 or advertisement 250. Accordingly, a user may interact with a digital image of web page 210 in a manner substantially similar to the manner in which a user may interact with the actual USPTO web page. For example, a user may scroll the page to view text or pictures, or may select the web page image to access links, advertisements, or other embedded content. Thus, the user is interacting with an image of the web page where the user may believe that he or she navigated to the actual USPTO web page by accessing the thumbnail image or URL on the search results page.

Continuing with the illustration, a user may desire to access embedded content, such as link 240 or advertisement 250 for example. To do so, such as previously described, a user may select link 240 or advertisement 250. That is, a user may select the portion of the digital image where link 240 or advertisement 250 may be located. As mentioned previously, embedded content may be associated with digital images such that a selection a portion of the page may result in corresponding content being accessed. For example, selection of link 240, which may include clicking a portion of an image to which link 240 may correspond, may result in content associated with that link being severed to a client computer. A more detailed explanation of content being served at least in part in response to a user selecting a portion of a digital image follows below.

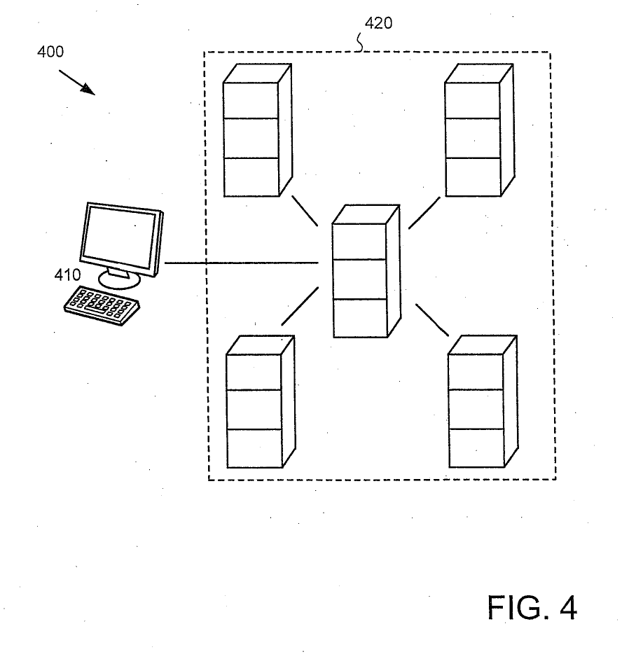

FIG. 4 is a schematic diagram depicting embodiment 400 of a system to serve digital images of web pages. For example, client computer 410 is depicted as being communicatively coupled to common Internet accessible database 420. In this embodiment, database 420 may be a server or a plurality of servers, such as an intranet of networked servers. For example, database 420 may be an intranet of networked servers operated by a search engine.

In embodiment 400, collected digital images of web pages and collected content or layout data may be stored in database 420. For example, database 420 may contain associated data collected in database 260 in FIG. 2. In this embodiment, client 410 may request search results, a particular web page, or a plurality of web pages, from database 420. Accordingly, for example, client 410 may send an HTML request to database 420. In response, database 420 may serve digital images of web pages with embedded content such as previously described.

In this embodiment, a user viewing a digital image of a web page on client computer 410 may desire to access embedded content. Accordingly, as suggested above, one way a user may access embedded content may be to select a portion of the digital image corresponding to the desired content. In this embodiment, for example, clicking on a digital image may send an HTTP request to database 420 for the corresponding content. In response, for example, database 420 may server another digital image of a web page with embedded content.

Of course, in this embodiment, database 420 may have already collected a digital image of a web page corresponding to content requested by the user selecting a link. Thus, in this embodiment, if a user selects content or submits a HTTP request for a web page that has been collected by database 420, a user may navigate between web pages by interacting with a plurality of digital images of web pages served via a single network of Intranet servers. Of course, in other embodiments, this may not always be the case. For example, database 420 may not have collected the image or content requested. In that instance, for example, database 420 may redirect a client to the actual web page, for example. Or, as another example, database 420 may notify a client that the requested web page has not been collected in its database. This may give the user an opportunity to determine whether he or she desired to leave what may be a trusted server database.

Various embodiments may a variety of advantages. For example, one advantage may be increased Web security. Users may have the ability to navigate the Web without leaving a trusted server, or a trusted network of servers. As mentioned previously, users typically search the Web by typing in search criteria and selecting a link, or accessing linked content from a web page, for example. This kind of surfing, such as previously described, may avail a user's computer or a user's personal or private information to malware or other pernicious software. Thus, in an embodiment described above, a user may be capable of surfing or navigating from website to website, at least in part, by accessing embedded content on digital images of web page. Accordingly, surfing on a trusted server or a network of trusted servers may decrease the need for malware protection schemes, such as anti-virus or anti-spyware software or certain types of firewall protection. In addition, privacy may be increased since surfing on a trusted server or network of servers may decrease the number of cookies or authentication schemes on a client's computing platform.

Another advantage of an embodiment may be that the Web may be faster to navigate. For example, related to the above, a potentially decreased need for malware protection, and firewall and authentication schemes that require processing by a server or a client computing platform, may speed up server/client performance. This may permit a user to navigate the Web faster. In addition, navigating the Web without being redirected and also having an opportunity to preview a particular web page, such as thumbnails, may also decrease Web navigation delays. Yet another related advantage may be that search engines, or other entities that may collect a database of web page images, may be better capable of tracking user navigation. These entities may track user data to update their search technology, which may potentially result in making search results more relevant to searchers.

Another advantage on an embodiment may be that searchers may encounter less unsolicited content on the Web. For example, a trusted server or network of servers may control which web page images it creates and which content it may collect in its database. Accordingly, a searcher utilizing a trusted server or network of servers may be better assured that she or he may not chance upon unsolicited content that she or he believes is inappropriate.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method, comprising:
serving a digital image of a web page, said image having at least one embedded link.

2. The method of claim 1, further comprising crawling the World Wide Web to collect images of web pages prior to serving.

3. The method of claim 2, wherein said crawling the World Wide Web comprises compiling content or layout data of said web pages prior to serving.

4. The method of claim 3, wherein said compiling content or layout data of web pages comprises compiling at least one of the following: HTML, CSS, hyperlinks, or a combination thereof.

5. The method of claim 3, further comprising associating layout data or embedded links of said web pages, at least in part, with said digital image of said web page, prior to serving.

6. The method of claim 1, wherein said digital image is served as part of a set of search results.

7. The method of claim 1, wherein said digital image of said web page comprises a thumbnail; and wherein selecting said thumbnail or dragging a cursor over said thumbnail enlarges said digital image.

8. The method of claim 1, wherein, prior to said serving said digital image of a web page, a link corresponding to said digital image is displayed with search results.

9. The method of claim 1, wherein said at least one embedded link corresponds to at least one link from an actual web page to which said digital image of corresponds.

10. A method, comprising:
receiving at a client a digital image of a web page, said image having at least one embedded link.

11. The method of claim 10, wherein said digital image of said web page was transmitted from a common Internet accessible database.

12. The method of claim 11, wherein said database resides on a server or on an intranet of networked servers.

13. The method of claim 10, wherein said digital image of said web page comprises a thumbnail; and wherein selecting said thumbnail or dragging a cursor over said thumbnail enlarges said image.

14. The method of claim 10, further comprising receiving at a client another digital image of a web page having at least one embedded link as a result of selecting at least one of said embedded links.

15. The method of claim 10, wherein said at least one embedded link corresponds to one or more advertisements.

16. The method of claim 10, wherein said at least one embedded link corresponds to at least one link from an actual web page to which said digital image of corresponds.

17. An apparatus, comprising:
a computing platform comprising a server; said computing platform further comprising a storage medium having instructions stored thereon; said storage medium, if said instructions are executed, further instructing said computing platform to serve a digital image of a web page having at least one embedded link.

18. The apparatus of claim 17, wherein said instructions, if executed, further result in said computing platform to crawl the World Wide Web to collect images of web pages or web page layout or content data, prior to serving.

19. The apparatus of claim 17, wherein said computing platform is communicatively coupled to a network.

20. The apparatus of claim 19, wherein said network is capable of being accessed via a common Internet accessible database.
